(19) United States
(12) Patent Application Publication
(10) Pub. No.: US 2010/0064252 A1
(43) Pub. Date: Mar. 11, 2010

(54) SYSTEMS AND METHODS FOR EXPANDING AND COLLAPSING DATA ENTRY REGIONS THAT DOES NOT HIDE ENTERED DATA

(75) Inventors: Richard Kramer, Orem, UT (US); Robert Whitney, Lakemoor, IL (US); Nicole Cragun, Kaysville, UT (US)

Correspondence Address: HANLEY, FLIGHT & ZIMMERMAN, LLC, 150 S. WACKER DRIVE, SUITE 2100, CHICAGO, IL, 60606, US

(73) Assignee: GENERAL ELECTRIC COMPANY, Schenectady, NY (US)

(21) Appl. No.: 12/206,471

(22) Filed: Sep. 8, 2008

(51) Int. Cl. G06F 3/048

(52) U.S. Cl. 715/810; 715/854

(57) ABSTRACT

Systems and methods are provided for expanding and collapsing data entry regions based on user input. An expander includes one or more items each having a header portion and a body portion. The header portion includes an identifier or label and can display additional information and/or control such as a set of physiologic normals. The body portion includes one or more options. A processor processes user input to update display of the expander. Contents of the expander are expanded or collapsed based on the user input. In an expanded state, the header portion and all options of the body portion for each of the one or more items are visible in the expander. In an collapsed state, the header portion and only options of the body portion selected by the user for each of the one or more items are visible in the expander.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present disclosure generally relates to user interface expander controls. More particularly, the present disclosure relates to adaptable expansion and collapsing of data entry regions.

Hospitals typically utilize computer systems to manage the various departments within a hospital, and data about each patient is collected by a variety of computer systems through a variety of interfaces and forms. Expanders are a component used in software development to group items of like kind together in a form or other electronic document. The expander provides a header label with a number of items available in the body of expander. The expander may be displayed in an expanded or collapsed state. In the expanded state, all items in the expander are visible and available for interaction. In a collapsed state, the expander hides all the items, making visible only the non-interactive header label. The user must fully expand the expander in order to interact with any item.

In clinical documentation, it is important to have all documented information visible to a reviewing clinician. Standard expanders have the potential to hide documented information. Clinical documentation presents a large amount of options for a clinician to select to describe a patient's condition. Given the large number of options and data entry points, there is potential for data related to the patient to be missed or overlooked.

### BRIEF SUMMARY OF THE INVENTION

Certain embodiments provide systems and methods for expanding and collapsing data entry regions in an electronic form based on user input.

Certain embodiments provide a clinical information system. The system includes a user interface providing electronic content to a user. The user interface includes an expander. The expander includes one or more items each having a header portion and a body portion. The header portion includes an identifier or label and can display additional information and/or control such as a set of physiologic normals. The body portion includes one or more options or controls with which the user may interact. The system also includes a processor that processes user input data via the user interface and the expander to update display of the user interface and the expander. The processor expands or collapses contents of the expander based on the user interaction. In the expanded state, the header portion and all options of the body portion show via the user interface all controls contained in the expander. In the collapsed state, the user interface shows only the header portion and all controls in the expander body that have data or have been selected by the user. Inside the expander body, any user controls that have not had user interaction are not displayed in the user interface.

Certain embodiments provide a machine-readable medium having a set of instructions for execution by a processor. The set of instructions includes a user interface routine providing electronic content to a user. The user interface routine includes an expander. The expander includes one or more items each having a header portion and a body portion. The header portion includes an identifier or label and can display additional information and/or control such as a set of physiologic normals. The body portion includes one or more options for selection by the user. The set of instructions also includes a processing routine processing user input data via the user interface routine and the expander to update display of the expander via the user interface routine. The processing routine expands or collapses contents of the expander based on the user input data to provide the expander in an expanded state or a collapsed state via the user interface routine. In the expanded state, the header portion and all options of the body portion for each of the one or more items are visible in the expander via the user interface routine. In the collapsed state, the header portion and only options of the body portion selected by the user for each of the one or more items are visible in the expander via the user interface routine.

Certain embodiments provide a method for expanding and collapsing data entry regions in an electronic form. The method includes displaying a user interface including an expander. The expander includes one or more items each having a header portion and a body portion. The header portion includes an identifier or label and can display additional information and/or control such as a set of physiologic normals. The body portion includes one or more options for selection by the user. The method also includes receiving and processing user input via the user interface to update display of the user interface including the expander. The method further includes collapsing or expanding content of the expander based on the user input to display the expander in the user interface in a collapsed state or an expanded state. In the expanded state, the header portion and all options of the body portion for each of the one or more items are visible in the expander. In the collapsed state, the header portion and only options of the body portion selected by the user for each of the one or more items are visible in the expander. Additionally, the method includes displaying the user interface to a user.

### BRIEF DESCRIPTION OF SEVERAL VIEWS OF THE DRAWINGS

FIG. 1 illustrates an example of an interface including a series of items for interaction and display in accordance with certain aspects or embodiments.

FIG. 2 depicts an example of an interface in which an abnormal or symptom option has been selected for an item in a body portion of an expander and is visible even when the items are collapsed in accordance with certain aspects or embodiments.

FIG. 3 shows an example of an expander control in an expanded state within a clinical application in accordance with certain aspects or embodiments.

FIG. 4 illustrates an expander control depicted in an expanded state with example user-entered data in accordance with certain aspects or embodiments.

FIG. 5 shows a collapsed expander control with selected values and associated notes visible in the collapsed state in accordance with certain aspects and embodiments.

FIG. 6 illustrates a flow diagram for a method for providing expandable and collapsible data entry regions in an electronic document or interface in accordance with certain aspects or embodiments.

FIG. 7 shows a block diagram of an example clinical information system capable of implementing example methods and systems described herein to provide expander controls to user in clinical interfaces/documents.

FIG. 8 depicts a block diagram of an example processing system for enabling improved expander functionality in accordance with certain aspects or embodiments.

FIG. 9 is a block diagram of an example processor system that may be used to implement systems and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Expanders are a component used in software development to group items of like kind together. An expander includes a header label portion with a number of items available in the body portion of the expander. The expander may be displayed in an expanded or collapsed state. In the expanded state, all items in the expander are visible and available for interaction. In a collapsed state, the expander hides all the items, making visible only the non-interactive header label.

Certain embodiments provide a multi-state expander providing varying degrees of viewing and/or hiding information in a form, interface, and/or other electronic document, for example. As described herein, a three-state expander will be used for purposes of illustration only, although a two-state expander or a more than three state expander is also envisioned. In certain embodiments, a first state (e.g., State #1) of a three state expander behaves like the expanded state of a standard expander in which a user can view all contents or collapse to hide all components.

A second state (e.g., State #2) is a collapsed state with one or more component(s) visible and able to be selectable or otherwise interactable in the header. In the second state, the header has a Header Label and one or more additional component(s). In either an expanded or collapsed state, a user may interact directly with the component(s) in the header. This interaction may determine behavior of components contained inside the expander (e.g., selecting a component checkbox de-selects all components within the expander and collapses the expander).

A third state (e.g., State #3) is a specialized view wherein the header maintains the interactions inherent in the traditional collapsed state. However, any options that have been interacted with by a user remain visible and remain selectable while any options that were not selected or otherwise utilized by the user are hidden. The third state allows a user to view and interact with key components while hiding unimportant components.

Certain embodiments provide a multi-state expander, such as a three state expander, that includes a component in an electronic form, interface, and/or document header that a user may interact with while the expander is in either an expanded or collapsed state. The header component indicates a common or default state, for example. The component in the header of the three state expander affects behavior of components within the expander (e.g., clear selected check boxes etc.). In a specialized collapsed state (e.g., referred to herein as State #3), the three state expander shows components within the expander that have been selected or interacted with while collapsing remaining non-selected or non-affected components. Using such a hybrid collapsed state, the three state expander helps facilitate quick selection of items and interaction with components without needing to expand the expander fully before component interaction. The three state expander provides an ability to expose to a user components that are contained in the expander when the expander is otherwise collapsed. A user can interact with a component in the header, and content that is selected can be visible and interactable when the expander is in a collapsed state.

In certain embodiments, a graphical user interface control allows data entry regions to be hidden and/or exposed using what is commonly known as expanding and collapsing behavior but does not hide entered data while in a collapsed state. For example, the user control allows users to hide regions that are not needed but will not hide any data that has been entered by the user unless otherwise controlled by the user to fully collapse or hide that data. Such partial or selective collapsing/expansion provides a safety measure to help prevent users from missing or overlooking data that would be hidden in a prior expander-style user control.

A prior expander hides every user control within its region when in a collapsed state and displays every user control within its region when in an expanded state. In certain embodiments, when the user control described herein is in a collapsed state, child controls within it are hidden if they do not contain user-entered data but controls with user-entered data to be hidden. When this control is in the expanded state, all child controls contained within it are displayed. This user control can be used in any graphical user interface where collapsing behavior is desired but user-entered data remains visible for safety or security reasons, such as a forms client, reporting tool, flowsheet, chart, etc.

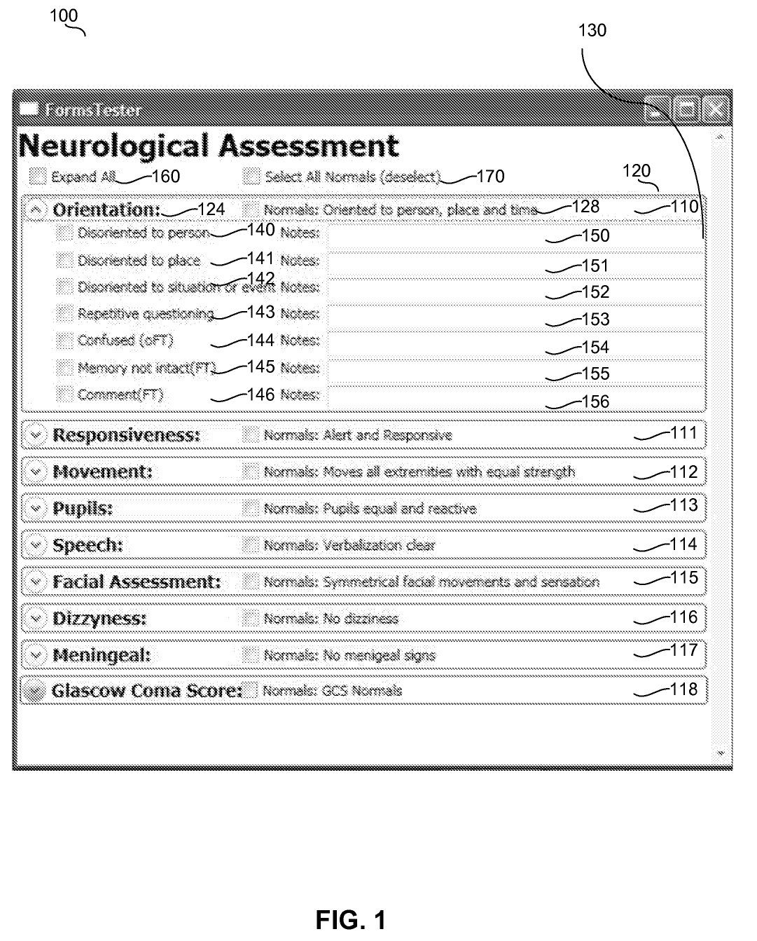

FIG. 1 illustrates an example of an interface 100 (e.g., a Neurological Assessment interface) including a series of items 110-118 for interaction and display. Each item 110-118 includes a header portion 120 and a body portion 130, as illustrated by the orientation item 110 in FIG. 1. The header portion 120 includes an identifier 124, such as a name (e.g., Orientation, Responsiveness, Movement, Pupils, Speech, Facial Assessment, Dizzyness, Meningeal, Glasgow Coma Score, etc.) and a check box and/or other selector 128. The check box/selector 128 allows a user to select a certain normal set of options, such as alert, oriented, verbalizes clearly, responsive, etc. The body portion 130 includes one or more options 140-146 identifying abnormalities and may also include a free-text and/or selectable notes field 150-156 for user comment. The interface 100 may also include global options to expand all 160 and select all normals 170, for example.

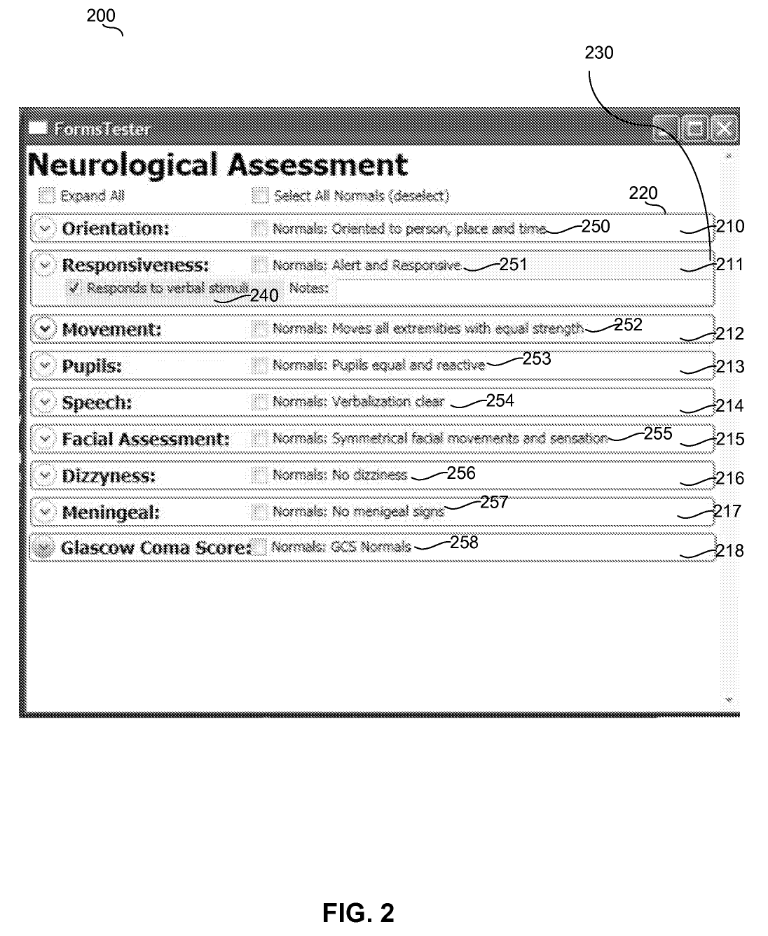

FIG. 2 depicts an example of an interface 200 in which an abnormal or symptom option 240 has been selected for an item 211 in a body portion 230 and is visible even when the items 210-218 are collapsed. Further, a collapsed view as shown in FIG. 2 allows a user to see and select normals 250-258 even while collapsed.

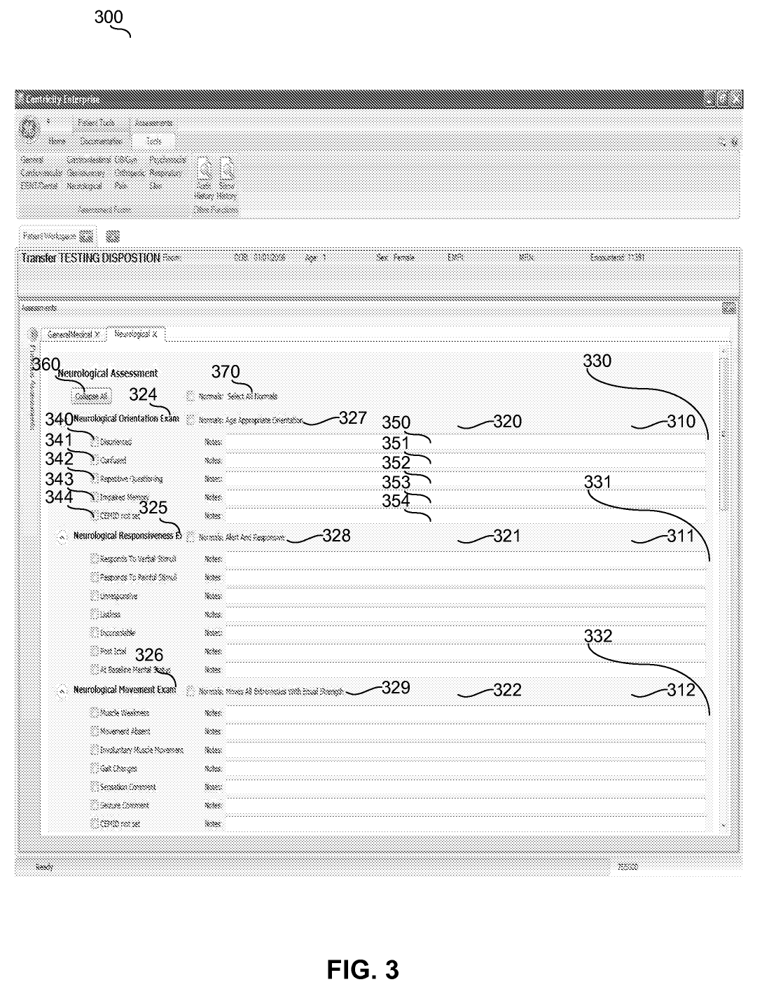

FIG. 3 shows an example of an expander control 300 in an expanded state within a clinical application, such as in a neurological assessment panel in GE's Centricity® Enterprise application. As in FIGS. 1 and 2, the expander control 300 includes a series of items 310-312 (e.g., neurological orientation exam, neurological responsiveness exam, neurological movement exam, etc.) for interaction and display. Each item 310-312 includes a header portion 320-322 and a body portion 330-332. The header portion 320-322 includes an identifier 324-326 and a check box and/or other selector 327-329. The check box/selector 327-329 allows a user to select a certain normal set of options, such as alert, oriented, verbalizes clearly, responsive, etc. The body portion 330-32 includes one or more options 340-344 identifying abnormalities and may also include a free-text and/or selectable notes fields 350-354 for user comment. The expander control 300 may also include global options to collapse all 360 and select all normals 370, for example.

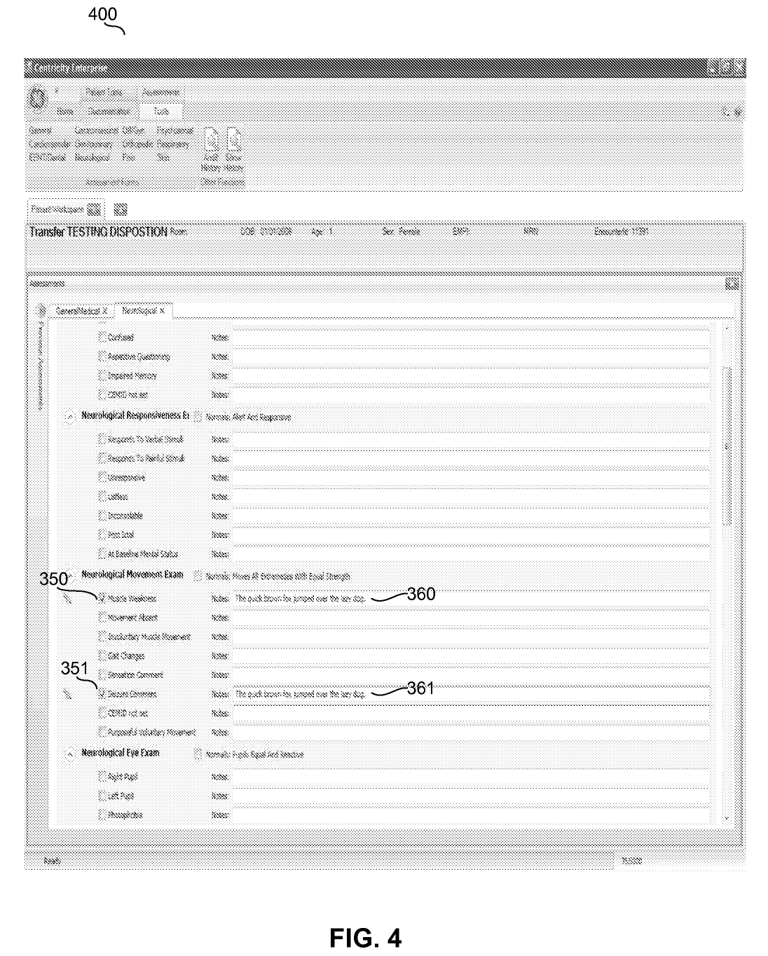

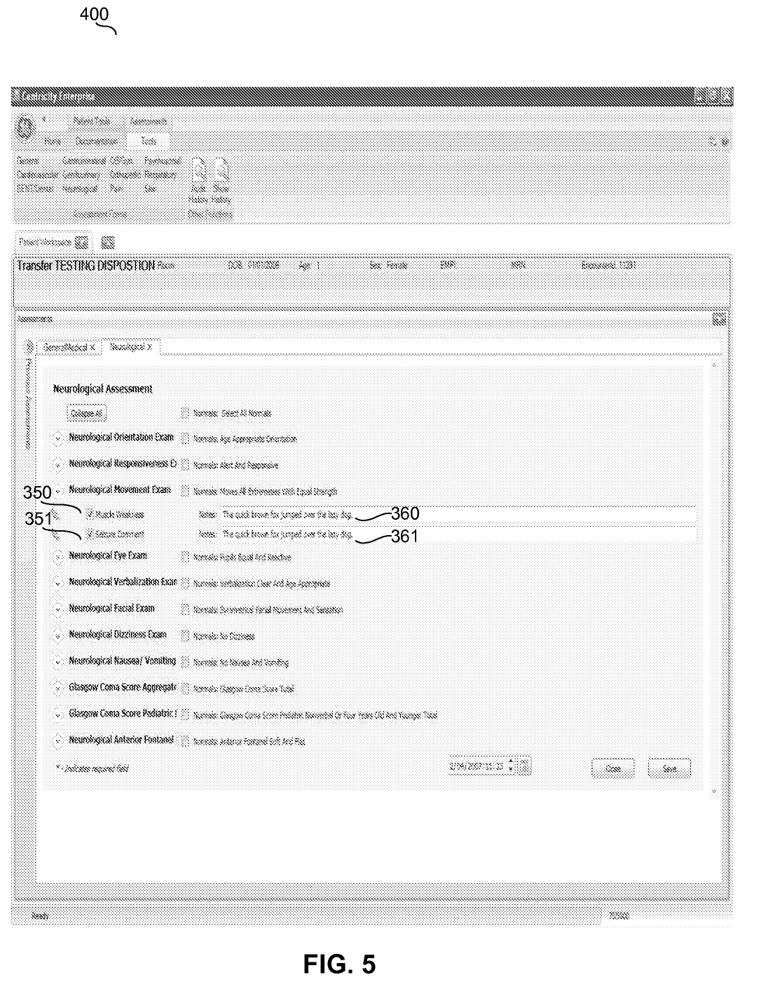

FIG. 4 illustrates an expander control 400 depicted in an expanded state with example user-entered data. The control 400 includes user-selected values 350, 351 and user-entered notes 360, 361 As shown in FIG. 5, collapsing the expander control 400 still leaves the selected values 350, 351 and the associated notes 360, 361 visible in the collapsed state.

As shown and described above, clinicians use assessment forms to document subjective and objective data. A clinician may use a variety of tools and mechanisms to do this. The expander control box is a container that can be used to box or group items that belong together. The expander control can expand and collapse to simplify presentation of information to a user. Both normal and abnormal information can be represented, expanded, and collapsed through an expander control, for example.

The expander can include a header and body. An example expander header includes three components: an expander button, an expander header label, and an expander normal statement check box with and associated label. Contents within the expander body are exposed when the expander is in expanded state. When in expanded state, a user can interact with the contents based on a control type. A user may press the expander button to expand the contents of the control box. For example, a current state of the control (expanded/collapsed) is checked when the expander button is pressed, a system toggles the state of the expander control.

A user may select or deselect the normal statement check box. Selection of the normal statement check box will reset all expander body content to a default initial state, for example. Selection or content interaction within the expander body will deselect the normal statement check box.

A user can interact with the content of the expander when the expander is in an expanded state. Content may include a combination of control types including check boxes, single select combo boxes, multi select combo boxes, radio buttons, combination, text boxes, input fields (numerical), etc. In certain embodiments, the expander body can contain custom user interface elements for forms flexibility.

When the expander is in expanded state, all controls within the expander are visible to a user. In an expanded state, behaviors related to available controls are supported. For example, when a check box for a comment is not checked, the associated text field is inactive. When the user checks the comment box, the text box is activated with focus placed in the text box. When the expander is in the collapsed state, all components are hidden with the exception of the controls that have content indicated. For example, a check box that is checked by a user is visible with an associated label in the collapsed state. Upon execution of a save function, the values of the expander body are saved as associated patient data, for example. In certain embodiments, pre-determined interaction with a control indicates to a system that the control is “active” and will be visible when the expander is in a collapsed state.

Certain embodiments described above describe an expander including a header with controls. In certain alternative embodiments, an expander can be implemented without a header. Additionally, while certain embodiments described above discuss control of a state of an expander by a user, in certain embodiments, the state of the expander can be controlled by a software program that the expander is used within as well as by the user.

In certain embodiments, when a previously saved form is loaded, the expander(s) of the form are by default in the collapsed state. If there is data in a user control within the expander, the user control is visible. In certain embodiments, the default can be adjusted to have the expanders load in an expanded state, etc. Additionally, certain embodiments provide an expand all and/or collapse all button that works with sets of expanders and can expand or collapse all of the expanders based on user selection, for example.

While certain embodiments described above illustrate free text fields used in conjunction with expander controls, any user control can be designed to work with the expanders including checkboxes with labels, sets of checkboxes with labels, radio buttons, etc. The free text user controls are illustrated in the figures for purposes of example only.

In certain embodiments, nested expanders can be used. That is, an expander can be used within an expander such that not all controls contained within an expander are necessarily for data entry purposes. If any child expander has data, all parent expanders containing it will remain visible when a collapse instruction is sent.

For example, a form may include an expander (a child) within an expander (a parent) both within another expander (a grandparent). If the child expander has a control with data, the control with data and the expander are visible when the parent is collapsed. If child expander has no data, it is not visible when parent is collapsed. If the child has data, the parent does not, and grandparent is collapsed, the child and parent expanders are both visible and the child's user control with data is visible. In the example, expander visibility is dependent upon whether any child user control includes data or if any of the children of any of its user controls include data.

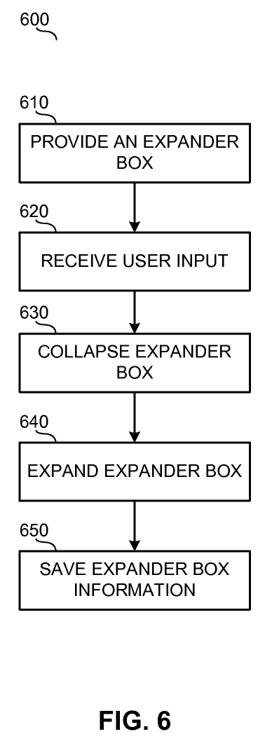

FIG. 6 illustrates a flow diagram for a method 600 for providing expandable and collapsible data entry regions in an electronic document or interface. At 610, an expander box is provided to a user in an electronic interface. For example, a box or section of a user interface can include one or more items each having one or more selectable options, such as disoriented, confused, repetitive questioning, impaired memory, etc., to describe a patient's condition. The box or other section can also include one or more free-text input fields associated with the one or more selectable options to allow a user to provide additional notes, attachment, and/or other input, for example.

At 620, user input regarding selection and/or other interaction with one or more items in the expander box is received. For example, as discussed above, the expander box can include one or more items, options, and fields for user input. A user can select one or more options for one or more of the items and/or provide input in one or more of the associated fields, and the user input is received for processing and/or other action, for example.

At 630, the expander box is collapsed based on user input. For example, a user may select a button, check box, and/or other functionality associated with the expander box to collapse the information in the expander box. In the event of a collapse, options and/or fields selected and/or input by the user can remain visible with their respective items while the remainder of the unselected options, fields, etc., are hidden, as described above. In certain embodiments, a complete collapsed state may also exist allowing even the user-selected options, etc., to be hidden.

At 640, the expander box is expanded based on user input. For example, a user may select a button, check box, and/or other functionality associated with the expander box to expand all or part of the information in the box. The user can then select and/or deselect options, enter information into the free-text fields, etc., while viewing the available opportunities in the expander box interface. Any changes made by the user can be reflected in the expander box representation when the user next collapses the box as well.

At 650, expander box information is saved. For example, option(s) selected, text entered, and/or other user interaction can be saved in the expander box interface or document for later retrieval/use. As another example, user input in the expander box can be propagated to another application, electronic document, electronic medical record, etc.

One or more of the steps of the method 600 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

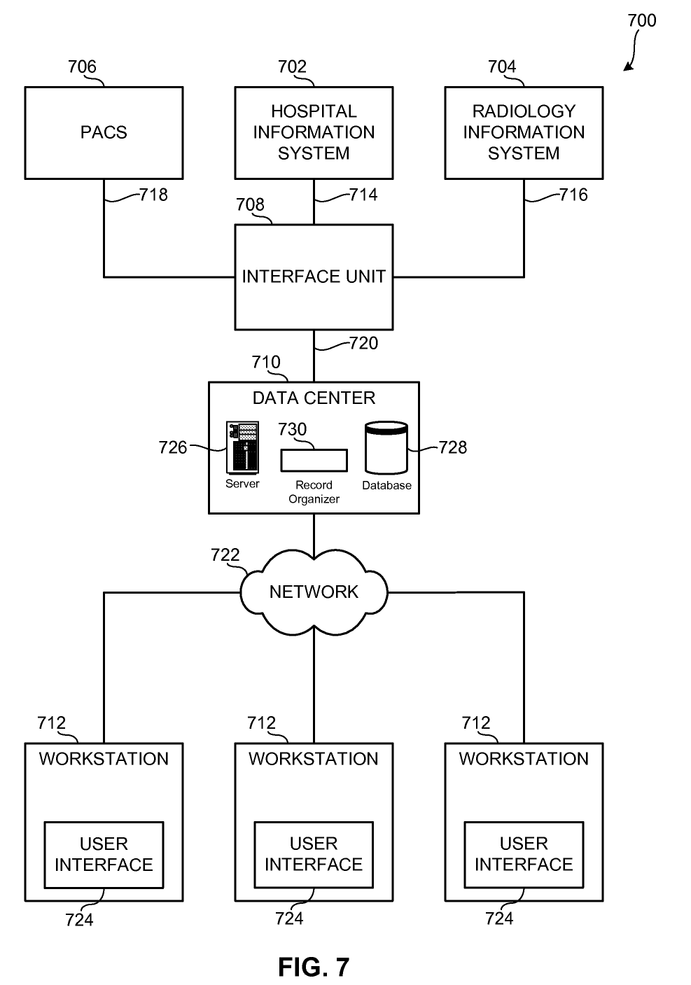

FIG. 7 shows a block diagram of an example clinical information system 700 capable of implementing the example methods and systems described herein to provide expander controls to user in clinical interfaces/documents. The example clinical information system 700 includes a hospital information system (“HIS”) 702, a radiology information system (“RIS”) 704, a picture archiving and communication system (“PACS”) 706, an interface unit 708, a data center 710, and a plurality of workstations 712. In the illustrated example, the HIS 702, the RIS 704, and the PACS 706 are housed in a healthcare facility and locally archived. However, in other implementations, the HIS 702, the RIS 704, and/or the PACS 706 may be housed one or more other suitable locations. Furthermore, one or more components of the clinical information system 700 may be combined and/or implemented together. For example, the RIS 704 and/or the PACS 706 may be integrated with the HIS 702; the PACS 706 may be integrated with the RIS 704; and/or the three example information systems 702, 704, and/or 706 may be integrated together. In other example implementations, the clinical information system 700 includes a subset of the illustrated information systems 702, 704, and/or 706. For example, the clinical information system 700 may include only one or two of the HIS 702, the RIS 704, and/or the PACS 706. Preferably, information (e.g., test results, observations, diagnosis, etc.) is entered into the HIS 702, the RIS 704, and/or the PACS 706 by healthcare practitioners (e.g., radiologists, physicians, and/or technicians) before and/or after patient examination.

The HIS 702 stores medical information such as clinical reports, patient information, and/or administrative information received from, for example, personnel at a hospital, clinic, and/or a physician's office. The RIS 704 stores information such as, for example, radiology reports, messages, warnings, alerts, patient scheduling information, patient demographic data, patient tracking information, and/or physician and patient status monitors. Additionally, the RIS 704 enables exam order entry (e.g., ordering an x-ray of a patient) and image and film tracking (e.g., tracking identities of one or more people that have checked out a film). In some examples, information in the RIS 704 is formatted according to the HL-7 (Health Level Seven) clinical communication protocol.

The PACS 706 stores medical images (e.g., x-rays, scans, three-dimensional renderings, etc.) as, for example, digital images in a database or registry. In some examples, the medical images are stored in the PACS 706 using the Digital Imaging and Communications in Medicine (“DICOM”) format. Images are stored in the PACS 706 by healthcare practitioners (e.g., imaging technicians, physicians, radiologists) after a medical imaging of a patient and/or are automatically transmitted from medical imaging devices to the PACS 706 for storage. In some examples, the PACS 706 may also include a display device and/or viewing workstation to enable a healthcare practitioner to communicate with the PACS 706.

The interface unit 708 includes a hospital information system interface connection 714, a radiology information system interface connection 716, a PACS interface connection 718, and a data center interface connection 720. The interface unit 708 facilities communication among the HIS 702, the RIS 704, the PACS 706, and/or the data center 710. The interface connections 714, 716, 718, and 720 may be implemented by, for example, a Wide Area Network (“WAN”) such as a private network or the Internet. Accordingly, the interface unit 708 includes one or more communication components such as, for example, an Ethernet device, an asynchronous transfer mode (“ATM”) device, an 802.11 device, a DSL modem, a cable modem, a cellular modem, etc. In turn, the data center 710 communicates with the plurality of workstations 712, via a network 722, implemented at a plurality of locations (e.g., a hospital, clinic, doctor's office, other medical office, or terminal, etc.). The network 722 is implemented by, for example, the Internet, an intranet, a private network, a wired or wireless Local Area Network, and/or a wired or wireless Wide Area Network. In some examples, the interface unit 708 also includes a broker (e.g., a Mitra Imaging's PACS Broker) to allow medical information and medical images to be transmitted together and stored together.

In operation, the interface unit 708 receives images, medical reports, administrative information, and/or other clinical information from the information systems 702, 704, 706 via the interface connections 714, 716, 718. If necessary (e.g., when different formats of the received information are incompatible), the interface unit 708 translates or reformats (e.g., into Structured Query Language (“SQL”) or standard text) the medical information, such as medical reports, to be properly stored at the data center 710. Preferably, the reformatted medical information may be transmitted using a transmission protocol to enable different medical information to share common identification elements, such as a patient name or social security number. Next, the interface unit 708 transmits the medical information to the data center 710 via the data center interface connection 720. Finally, medical information is stored in the data center 710 in, for example, the DICOM format, which enables medical images and corresponding medical information to be transmitted and stored together.

The medical information is later viewable and easily retrievable at one or more of the workstations 712 (e.g., by their common identification element, such as a patient name or record number). The workstations 712 may be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. The workstations 712 receive commands and/or other input from a user via, for example, a keyboard, mouse, track ball, microphone, etc. As shown in FIG. 7, the workstations 712 are connected to the network 722 and, thus, can communicate with each other, the data center 710, and/or any other device coupled to the network 722. The workstations 712 are capable of implementing a user interface 724 to enable a healthcare practitioner to interact with the clinical information system 700. For example, in response to a request from a physician, the user interface 724 presents a patient medical history. Additionally, the user interface 724 includes one or more options related to the example methods and apparatus described herein to organize such a medical history using classification and severity parameters.

The example data center 710 of FIG. 7 is an archive to store information such as, for example, images, data, medical reports, and/or, more generally, patient medical records. In addition, the data center 710 may also serve as a central conduit to information located at other sources such as, for example, local archives, hospital information systems/radiology information systems (e.g., the HIS 702 and/or the RIS 704), or medical imaging/storage systems (e.g., the PACS 706 and/or connected imaging modalities). That is, the data center 710 may store links or indicators (e.g., identification numbers, patient names, or record numbers) to information. In the illustrated example, the data center 710 is managed by an application server provider (ASP) and is located in a centralized location that may be accessed by a plurality of systems and facilities (e.g., hospitals, clinics, doctor's offices, other medical offices, and/or terminals). In some examples, the data center 710 may be spatially distant from the HIS 702, the RIS 704, and/or the PACS 706 (e.g., at General Electric® headquarters).

The example data center 710 of FIG. 7 includes a server 726, a database 728, and a record organizer 730. The server 726 receives, processes, and conveys information to and from the components of the clinical information system 700. The database 728 stores the medical information described herein and provides access thereto. The example record organizer 730 of FIG. 7 manages patient medical histories, for example.

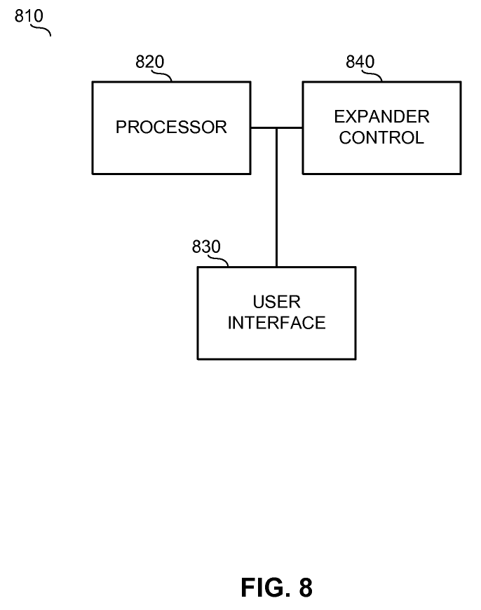

FIG. 8 depicts a block diagram of an example processing system 810 for enabling improved expander functionality. As shown in FIG. 8, the interface processing system 810 includes a processor 820, a user interface 830, and an expander control 840. The processor 820 may be any suitable processor, processing unit, or microprocessor, for example. Although not shown in FIG. 8, the system 810 may be a multi-processor system and, thus, may include one or more additional processors that are identical or similar to the processor 812 and that are communicatively coupled through a bus or other connection, for example.

The processor 820 includes and/or is in communication with a memory that includes instructions and data for providing the user interface 830 for display to and interaction with a user, for example. The expander control 840 appears as part of the user interface 830. For example, the expander control 840 can include one or more items each having one or more selectable options, such as muscle weakness, movement absent, involuntary muscle movement, gait changes, sensation comment, seizure comment, etc., to describe a patient's condition. The expander control can also include one or more free-text input fields associated with the one or more selectable options to allow a user to provide additional notes, attachment, and/or other input, for example.

Based on input from a user via the interface 830, the processor 820 can update the content and appearance of the expander control 840. For example, a user can select one or more options for one or more of the items and/or provide input in one or more of the associated fields, and the user input is received for processing and/or other action by the processor 820. For example, a user may select a button, check box, and/or other functionality associated with the expander control 840 to collapse the information in the expander control 840. In the event of a collapse, options and/or fields selected and/or input by the user can remain visible with their respective items while the remainder of the unselected options, fields, etc., are hidden, as described above. In certain embodiments, a complete collapsed state may also exist allowing even the user-selected options, etc., to be hidden. As another example, a user may select a button, check box, and/or other functionality associated with the expander control 840 to expand all or part of the information in the box. The user can then select and/or deselect options, enter information into the free-text fields, etc., while viewing the available opportunities in the expander control 840 and user interface 830. Any changes made by the user can be reflected in the expander control 840 representation when the user next collapses the control 840 as well.

In an alternative embodiment, an expander control 840 header can provide an indication of items/options selected in the expander control 840 body. For example, if the expander provides a header of “X” and a body including selections “A” “B” “C” “D” and “E”, and a user interacts with (e.g., selects, checks, etc) “A”, “C”, and “D”, a collapsed expander control 840 can include header text that changes from “X” to “X-A, C, and D have been selected”, for example. Thus, the header may state, as an example, “Neurological Movement Exam” and, when collapsed, may read “Neurological Movement Exam—Muscle Weakness and Seizure Comment selected.”

The processor 820 can save information and user input from the expander control 840 and user interface 830 for later retrieval and/or use, for example. The processor 820 can also process and/or transmit user input to another clinical application, electronic document, electronic medical record, etc.

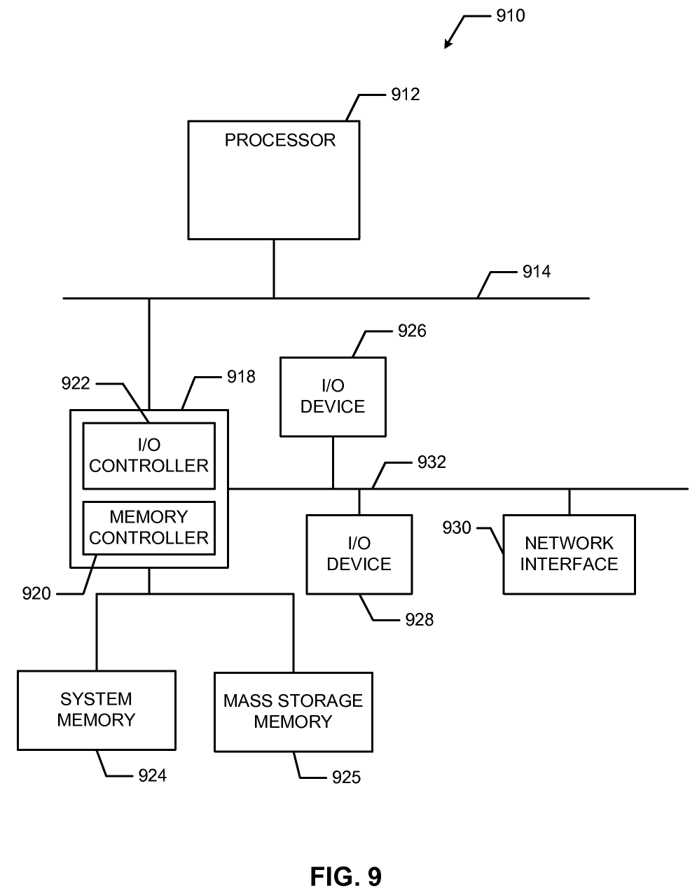

FIG. 9 is a block diagram of an example processor system 910 that may be used to implement the systems and methods described herein. As shown in FIG. 9, the processor system 910 includes a processor 912 that is coupled to an interconnection bus 914. The processor 912 may be any suitable processor, processing unit, or microprocessor, for example. Although not shown in FIG. 9, the system 910 may be a multi-processor system and, thus, may include one or more additional processors that are identical or similar to the processor 912 and that are communicatively coupled to the interconnection bus 914.

The processor 912 of FIG. 9 is coupled to a chipset 918, which includes a memory controller 920 and an input/output (“I/O”) controller 922. As is well known, a chipset typically provides I/O and memory management functions as well as a plurality of general purpose and/or special purpose registers, timers, etc. that are accessible or used by one or more processors coupled to the chipset 918. The memory controller 920 performs functions that enable the processor 912 (or processors if there are multiple processors) to access a system memory 924 and a mass storage memory 925.

The system memory 924 may include any desired type of volatile and/or non-volatile memory such as, for example, static random access memory (SRAM), dynamic random access memory (DRAM), flash memory, read-only memory (ROM), etc. The mass storage memory 925 may include any desired type of mass storage device including hard disk drives, optical drives, tape storage devices, etc.

The I/O controller 922 performs functions that enable the processor 912 to communicate with peripheral input/output (I/O) devices 926 and 928 and a network interface 930 via an I/O bus 932. The I/O devices 926 and 928 may be any desired type of I/O device such as, for example, a keyboard, a video display or monitor, a mouse, etc. The network interface 930 may be, for example, an Ethernet device, an asynchronous transfer mode (“ATM”) device, an 802.11 device, a DSL modem, a cable modem, a cellular modem, etc. that enables the processor system 910 to communicate with another processor system.

While the memory controller 920 and the I/O controller 922 are depicted in FIG. 9 as separate blocks within the chipset 918, the functions performed by these blocks may be integrated within a single semiconductor circuit or may be implemented using two or more separate integrated circuits.

In prior expanders, a user was not able to interact within the header but could only expand or collapse the contents. Here, in certain embodiments, if a user documents items in the expander body and collapses the expander, those affected items still appear to the user. Thus, certain embodiments provide a technical effect of collapsing an expander and still displaying user-selected components. Certain embodiments provide global options in an expander header for selecting all items in an expander body, clearing all items in the expander body, selecting a normal group of options for an expander item or category, and the like. While users of prior expanders are liable to overlook a few checked items among a large number of unchecked items, certain embodiments provide users with an ability to expand or collapse and still see relevant information. Using a multi-state expander allows access to all available documentation elements, for example, but when a clinician is reviewing patient documentation, only the documented elements are visible to reduce clutter and interference and help streamline clinician workflow, for example.

In certain embodiments, an expander header includes not only a label, but other interactive controls, such as a normal statement. In certain embodiments, controls in the header impact the body of the expander, such as having it expand, collapse, etc. If a user selects a normal, the header control will deselect appropriate controls in the body of the expander and collapse the expander. In certain embodiments, the body of the expander can have a multitude of different controls for user interaction. Interaction with these controls may change a state of a control in the header. Additionally, if a user or program has interacted with a control in the body (e.g., selected, text entered, selection from a pick-list, etc.) then, when the expander is collapsed, the controls that have been interacted with are not collapsed. In certain embodiments, expander visibility is dependent upon whether any child user control includes data or if any of the children of any of its user controls include data, for example.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

For example, certain embodiments can be implemented as a machine-readable medium having a set of instructions for execution by a processor. The set of instructions includes a user interface routine providing electronic content to a user. The user interface routine includes an expander. The expander includes one or more items each having a header portion and a body portion. The header portion includes an identifier and a set of normals. The body portion includes one or more options for selection by the user. The set of instructions also includes a processing routine processing user input data via the user interface routine and the expander to update display of the expander via the user interface routine. The processing routine expands or collapses contents of the expander based on the user input data to provide the expander in an expanded state or a collapsed state via the user interface routine. In the expanded state, the header portion and all options of the body portion for each of the one or more items are visible in the expander via the user interface routine. In the collapsed state, the header portion and only options of the body portion selected by the user for each of the one or more items are visible in the expander via the user interface routine.

In certain embodiments, the body portion of at least one of the one or more items further includes one or more notes fields for free-text input by the user. Each of the one or more notes fields is associated with one of the one or more options for selection by the user. In the collapsed state, the one or more notes fields that have been modified by the user are visible in the expander via the user interface routine.

In certain embodiments, the header portion of the expander and the visible options in the body portion are selectable by the user in the collapsed state. In certain embodiments, the expander further includes a selector to select all normals for each of the one or more items in the expander. In certain embodiments, the selector also allows a user to deselect all normals for each of the one or more items in the expander.

In certain embodiments, the expander includes a fully collapsed state hiding all options in each of the one or more items and showing the header portion for each of the one or more items in the expander via the user interface routine. In certain embodiments, the user interface routine displays an electronic form for completion by the user including the expander.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A clinical information system, said system comprising:
a user interface providing electronic content to a user, said user interface including an expander, said expander including one or more items each having a header portion and a body portion, said header portion including an identifier and a control, said body portion including one or more options for interaction by the user; and
a processor processing user input data via said user interface and said expander to update display of said user interface and said expander, said processor expanding or collapsing contents of said expander based on the user input data to provide said expander in said user interface in an expanded state or a collapsed state,
wherein, in said expanded state, said header portion and all options of said body portion for each of said one or more items are visible in said expander via said user interface and wherein, in said collapsed state, said header portion and only options of said body portion selected by the user for each of said one or more items are visible in said expander via said user interface.

2. A system according to claim 1, wherein said body portion of at least one of said one or more items further comprises one or more notes fields for free-text input by the user, each of the one or more notes fields associated with one of the one or more options for selection by the user, and wherein, in said collapsed state, said one or more notes fields that have been modified by the user are visible in said expander via said user interface.

3. A system according to claim 1, wherein said header portion of said expander and said visible options in said body portion are selectable by the user in said collapsed state.

4. A system according to claim 1, wherein said expander further comprises a selector to select all normals for each of said one or more items in said expander.

5. A system according to claim 4, wherein said selector also allows a user to deselect all normals for each of said one or more items in said expander.

6. A system according to claim 1, wherein said expander includes a fully collapsed state hiding all options in each of said one or more items and showing said header portion for each of said one or more items in said expander via said user interface.

7. A system according to claim 1, wherein said user interface displays an electronic form for completion by the user including said expander.

8. A system according to claim 1, wherein said control comprises a set of physiologic normals.

9. A machine-readable medium having a set of instructions for execution by a processor, said set of instructions comprising:
a user interface routine providing electronic content to a user, said user interface routine including an expander, said expander including one or more items each having a header portion and a body portion, said header portion including an identifier and a set of normals, said body portion including one or more options for selection by the user; and
a processing routine processing user input data via said user interface routine and said expander to update display of said expander via said user interface routine, said processing routine expanding or collapsing contents of said expander based on the user input data to provide said expander in an expanded state or a collapsed state via said user interface routine,
wherein, in said expanded state, said header portion and all options of said body portion for each of said one or more items are visible in said expander via said user interface routine and wherein, in said collapsed state, said header portion and only options of said body portion selected by the user for each of said one or more items are visible in said expander via said user interface routine.

10. A machine-readable medium according to claim 9, wherein said body portion of at least one of said one or more items further comprises one or more notes fields for free-text input by the user, each of the one or more notes fields associated with one of the one or more options for selection by the user, and wherein, in said collapsed state, said one or more notes fields that have been modified by the user are visible in said expander via said user interface routine.

11. A machine-readable medium according to claim 9, wherein said header portion of said expander and said visible options in said body portion are selectable by the user in said collapsed state.

12. A machine-readable medium according to claim 9, wherein said expander further comprises a selector to select all normals for each of said one or more items in said expander.

13. A machine-readable medium according to claim 12, wherein said selector also allows a user to deselect all normals for each of said one or more items in said expander.

14. A machine-readable medium according to claim 9, wherein said expander includes a fully collapsed state hiding all options in each of said one or more items and showing said header portion for each of said one or more items in said expander via said user interface routine.

15. A machine-readable medium according to claim 9, wherein said user interface routine displays an electronic form for completion by the user including said expander.

16. A method for expanding and collapsing data entry regions in an electronic form, said method comprising:
displaying a user interface including an expander, said expander including one or more items each having a header portion and a body portion, said header portion including an identifier and a control, said body portion including one or more options for selection by the user;
receiving and processing user input via said user interface to update display of said user interface including said expander;
collapsing or expanding content of said expander based on the user input to display said expander in said user interface in a collapsed state or an expanded state, wherein, in said expanded state, said header portion and all options of said body portion for each of said one or more items are visible in said expander and wherein, in said collapsed state, said header portion and only options of said body portion selected by the user for each of said one or more items are visible in said expander; and
displaying said user interface to a user.

17. A method according to claim 16, wherein said body portion of at least one of said one or more items further comprises one or more notes fields for free-text input by the user, each of the one or more notes fields associated with one of the one or more options for selection by the user, and wherein, in said collapsed state, said one or more notes fields that have been modified by the user are visible in said expander.

18. A method according to claim 16, wherein said header portion of said expander and said visible options in said body portion are selectable by the user in said collapsed state.

19. A method according to claim 16, wherein said expander further comprises a selector to select or deselect all normals for each of said one or more items in said expander.

20. A method according to claim 16, wherein said expander includes a fully collapsed state hiding all options in each of said one or more items and showing said header portion for each of said one or more items in said expander via said user interface.

21. A method according to claim 16, wherein said user interface displays an electronic form for completion by the user including said expander.

22. A method according to claim 16, wherein said control comprises a set of physiologic normals.
